(19) United States
(12) Patent Application Publication
(10) Pub. No.: US 2026/0144618 A1
(43) Pub. Date: May 28, 2026

(54) DEVICES FOR ORAL TISSUE REGENERATION

(71) Applicant: Align Technology, Inc., San Jose, CA (US)

(72) Inventors: Michael Christopher Cole, San Jose, CA (US); Jun Sato, San Jose, CA (US); John Y. Morton, San Jose, CA (US)

(21) Appl. No.: 19/312,939

(22) Filed: Aug. 28, 2025

Related U.S. Application Data
(60) Provisional application No. 63/689,370, filed on Aug. 30, 2024.
(60) Provisional application No. 63/789,029, filed on Apr. 15, 2025.

(51) Int. Cl. A61C 8/02; A61C 8/00

(52) U.S. Cl. CPC A61C 8/0006; A61C 8/0016

(57) ABSTRACT

Devices and methods for treating an intraoral cavity of a patient are provided. In some embodiments, a device includes a tissue scaffold configured to promote growth of oral tissue at a treatment site in the intraoral cavity of the patient, and a positioner. The positioner can include one or more cavities configured to receive one or more teeth of the patient, and an alignment element configured to temporarily couple to the tissue scaffold such that when the positioner is placed on the patient's teeth, the alignment element locates the tissue scaffold at the treatment site.

### CROSS-REFERENCE TO RELATED APPLICATION(S)

The present application claims the benefit of priority to U.S. Provisional Application No. 63/689,370, filed Aug. 30, 2024, and U.S. Provisional Application No. 63/789,029, filed Apr. 15, 2025, each of which is incorporated by reference herein in its entirety.

### TECHNICAL FIELD

The present technology generally relates to medical devices, and in particular, to devices for oral tissue regeneration.

### BACKGROUND

Gum recession occurs when the gum tissue around the teeth deteriorates or otherwise pulls away from the teeth over time. Although gum recession is generally only a mild health issue and is primarily a cosmetic problem in early stages, continued recession of the gums exposes the tooth root which leads to more facile tooth decay since the root does not have the hard enamel coating present on the rest of the tooth. As the gums recede further, more of the root is exposed. Moreover, the bone holding the tooth and supporting the gum tissue becomes susceptible to bacterial attack, which can eventually lead to periodontal disease. Once the bone becomes infected, the bone starts to erode away which can accelerate the loss of gum tissue, setting up a rapid deterioration of the surrounding tissues and eventually the loss of the tooth. Additionally, oral health may be directly linked to other health issues, such as heart health (e.g., oral bacteria have been linked to issues with heart valves) and premature births of infants in pregnant women. Surgery (e.g., tissue grafting) is the only treatment currently available for gum recession, but surgery is invasive, painful, and expensive for the patient.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIGS. 1A-1D illustrate progression of periodontal disease.

FIGS. 2A-2D are partially schematic illustrations providing a general overview of a device for treating an intraoral cavity of a patient, in accordance with embodiments of the present technology.

FIG. 3A illustrates a perspective view of a device including a tissue scaffold and a positioner, in accordance with embodiments of the present technology.

FIG. 3B illustrates a perspective view of a device including a tissue scaffold and a positioner, in accordance with embodiments of the present technology.

FIG. 4A illustrates a perspective view of a device including a tissue scaffold and a positioner, in accordance with embodiments of the present technology.

FIG. 4B illustrates a perspective view of a device including a tissue scaffold and a positioner, in accordance with embodiments of the present technology.

FIG. 5 is a flow diagram illustrating a method for designing and/or fabricating a device for treating a patient's intraoral cavity, in accordance with embodiments of the present technology.

FIG. 6 is a flow diagram illustrating a method for treating a patient's intraoral cavity, in accordance with embodiments of the present technology.

FIG. 7 is a partially schematic diagram providing a general overview of an additive manufacturing process, in accordance with embodiments of the present technology.

### DETAILED DESCRIPTION

The present technology relates to devices and methods for regeneration of tissues, such as oral tissues. In some embodiments, for example, a device includes a tissue scaffold configured to promote growth of oral tissue at a treatment site in the intraoral cavity of the patient, and a positioner (e.g., a polymeric shell or a plurality of interconnected registration elements). The tissue scaffold can be a biodegradable polymer scaffold that promotes the infiltration, proliferation, and/or differentiation of oral tissue. The positioner can include one or more cavities configured to receive one or more teeth of the patient, and an alignment element configured to temporarily couple to the tissue scaffold such that when the positioner is placed on the patient's teeth, the alignment element locates the tissue scaffold at the treatment site. Optionally, the positioner and/or tissue scaffold may be additively manufactured.

The devices herein may be used to direct regrowth of gum tissue and/or other oral tissues without surgery (e.g., without gum graft surgery). The device can be placed onto the gum area to be regrown and attached to a tooth to keep the scaffold properly anchored during tissue regrowth. Over time, the adjacent gum tissue can grow capillaries into the tissue scaffold as the tissue scaffold degrades. Endogenous stem cells can migrate into the area and based on chemical, physical, and/or biological cues provided by the scaffold material, the stem cells can differentiate into the appropriate tissue structures to recreate healthy gum tissue, which may gradually replace the tissue scaffold as it degrades. In some embodiments, the tissue scaffold serves as a template for direct regrowth of alveolar bone and periodontal ligaments. In other embodiments, the tissue scaffold can serve as a replacement to these tissues that remains in place permanently.

The present technology can provide many advantages compared to conventional approaches for oral tissue regeneration. For instance, gum graft surgery is typically indicated for treatment of severe gum recession, but this procedure is invasive and painful for the patient. Moreover, recession may reoccur if the underlying bone is not restored together with the soft tissue. Furthermore, conventional implantable scaffolds for regeneration of tissue are typically placed manually, which may lead to inaccuracies in positioning, particularly for hard to reach areas (e.g., posterior teeth). The devices and methods described herein can address these and other challenges by providing a positioner and tissue scaffold that are customized (e.g., digitally designed) to fit the particular patient's anatomy (e.g., the size, shape, and location of the teeth and treatment site). The use of a positioner can improve the accuracy and consistency of placement of the tissue scaffold, e.g., compared to manual placement. Moreover, the tissue scaffold may be placed without requiring surgery and/or suturing, which can reduce pain and produce faster healing for the patient.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Oral Tissue Regeneration

The present technology provides tissue scaffolds that may be used to regenerate oral tissue, and associated devices (e.g., positioners that may be used to place a tissue scaffold at a treatment site). In some embodiments, a tissue scaffold is used to promote regrowth of gum tissue directly proximate to the teeth. For example, a tissue scaffold can be used to perform one or more of the following therapeutic functions: regrowing gum tissue, replacing gum tissue with a substitute material, restoring the gum line to the root-enamel boundary, decreasing pocket depth, regrowing ligaments, replacing ligaments with a substitute material, regrowing bone, replacing bone with a substitute material, and/or replacing at least a portion of a tooth with a substitute material. Although certain embodiments of the present technology are described below in connection with regeneration of oral tissues for treating periodontal disease, the present technology may be used to regenerate oral tissues for treatment of other intraoral diseases or conditions, such as for cleft lip repair, cleft palate repair, alveolar bone grafting, orthognathic surgery, etc.

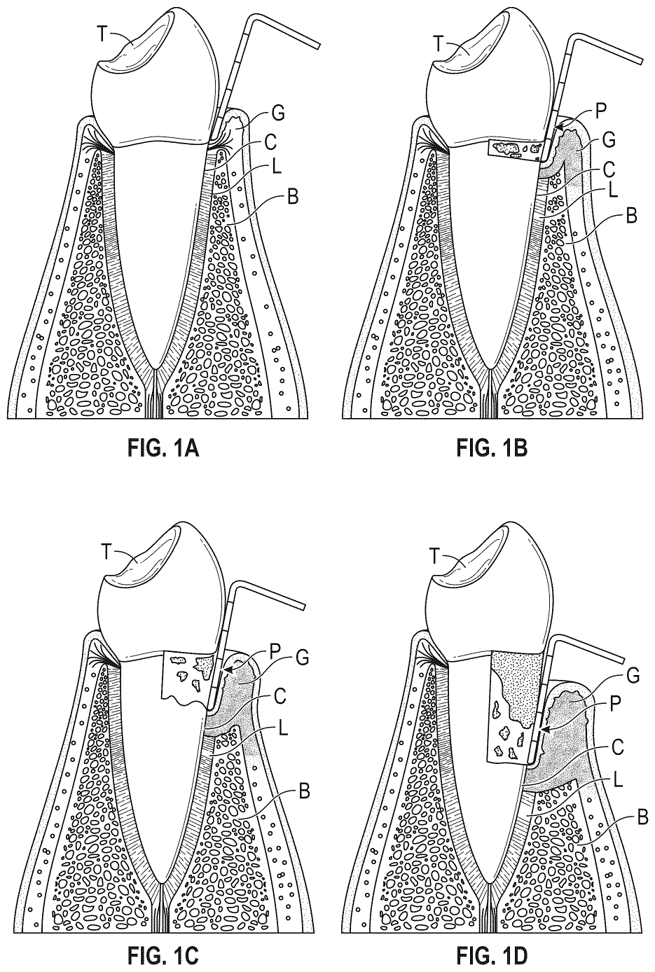

FIGS. 1A-1D illustrate progression of periodontal disease. Referring first to FIG. 1A, a tooth T with healthy supporting tissue, such as gingiva G, cementum C, ligaments L (e.g., a periodontal ligament (PDL)), and bone B, is shown. Referring next to FIG. 1B, poor oral hygiene may result in buildup of bacterial plaque on the tooth T, leading to inflammation of the gingiva G. The gingiva G may pull away from the tooth T, thus forming a periodontal pocket P. Minor erosion of the cementum C, ligaments L, and/or bone B may also occur at this stage. Referring next to FIG. 1C, as the periodontal disease progresses, the periodontal pocket P may deepen, allowing bacteria to invade deeper into the tissue and causing further loss of the cementum C, ligaments L, and/or bone B. Referring next to FIG. 1D, in advanced periodontal disease, significant deepening of the periodontal pocket P and loss of the cementum C, ligaments L, and/or bone B has occurred, which may lead to loosening or even loss of the tooth T.

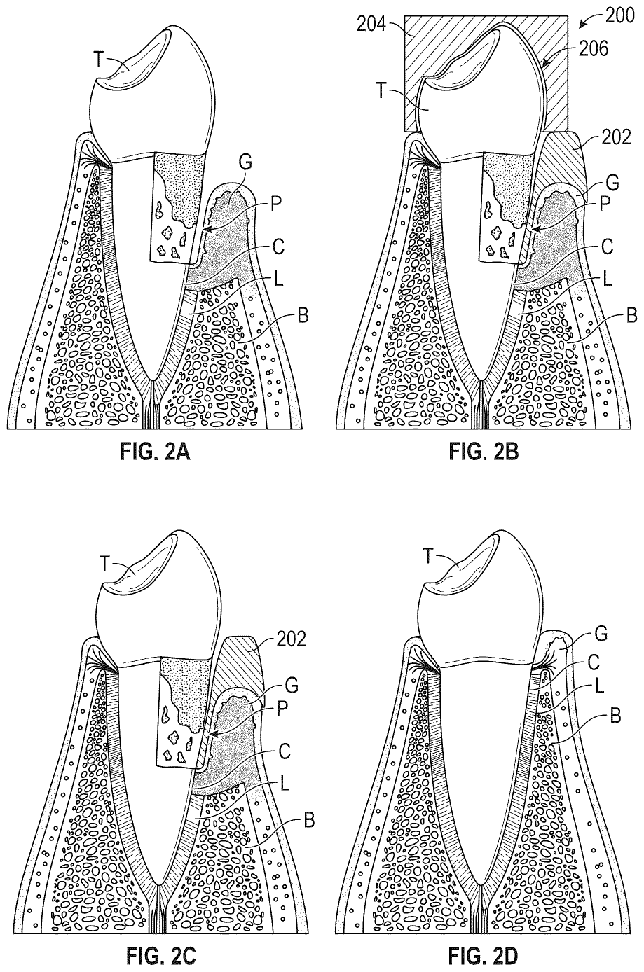

FIGS. 2A-2D are partially schematic illustrations providing a general overview of a device 200 for treating an intraoral cavity of a patient, in accordance with embodiments of the present technology. Referring first to FIG. 2A, gingival recession proximate to a tooth T can result in formation of a deep pocket P, exposure of the tooth root, and/or loss of native tissues such as gingiva G, bone B, cementum C, and/or ligaments L, as previously discussed with respect to FIGS. 1A-1D.

Referring next to FIG. 2B, the device 200 can include a tissue scaffold 202 and a positioner 204 (shown schematically). The tissue scaffold 202 is configured to promote the growth of oral tissue at a treatment site, such as gingiva G, bone B, cementum C, and/or ligaments L. In some embodiments, the tissue scaffold 202 is placed into and/or proximate to a treatment site in the intraoral cavity where regeneration of oral tissue is desired (e.g., within or proximate to a gum recession site of the tooth T). For example, the tissue scaffold 202 can fit partially or entirely into the pocket P adjacent to the root of the tooth T, and proximate to the gingiva G, bone B, cementum C, and/or ligaments L.

The tissue scaffold 202 can be made from one or more biocompatible materials, such as one or more biocompatible polymers (e.g., aliphatic polyesters, polyanhydrides, polyphosphazenes, poly(ethylene glycol)). The tissue scaffold 202 can include bioactive agents to promote cell migration, proliferation, and/or differentiation (e.g., growth factors, inorganic minerals, small molecule drugs, cells). The tissue scaffold 202 may or may not be biodegradable. Additional details of materials that may be used in the tissue scaffold 202 are provided in Section I.B below.

The positioner 204 (also known as a “scaffold placement template” or “template”) can be temporarily coupled to the tissue scaffold 202 to locate the tissue scaffold 202 at the treatment site. In some embodiments, the positioner 204 includes one or more cavities 206 configured to receive one or more teeth of the patient at or near the treatment site. For instance, in the illustrated example, the positioner 204 can include a shell, registration element, or other similar structure having a cavity 206 that is configured to receive at least a portion of the tooth T proximate to the treatment site (e.g., at least the crown of the tooth T). Alternatively or in combination, the positioner 204 can include other structures that couple to a patient's dentition, such as pins, pegs, etc. The positioner 204 is configured to couple to the tissue scaffold 202 in a predetermined position and orientation such that when the positioner 204 is positioned on the tooth, the tissue scaffold 202 is located at the treatment site proximate to the tooth (e.g., within the pocket P). The positioner 204 can include at least one alignment element (e.g., one or more openings, struts, guides—not shown) that couples to the tissue scaffold 202 to place the tissue scaffold 202 at the desired position and orientation at the treatment site. Additional details of features that may be used for the positioner 204 and alignment element are provided in Section I.A below.

Optionally, the treatment site may be prepared before placement of the tissue scaffold 202. In such embodiments, the preparation may include descaling of the root (e.g., deep cleaning of the pocket P), cleaning of the tooth surface, and/or abrasion or cutting of the gingival tissue (e.g., removal of surface layers). The preparation may enhance tissue ingrowth into the tissue scaffold 202 and/or reduce the likelihood of infection at the treatment site, for example.

Referring next to FIG. 2C, after the tissue scaffold 202 is placed at the treatment site, the positioner 204 can then be removed from the tissue scaffold 202 (e.g., by fracturing a portion of the positioner 204, by decoupling a fastener attaching the tissue scaffold 202 to the positioner 204), leaving the tissue scaffold 202 in place. In some embodiments, the tissue scaffold 202 is secured to the treatment site (e.g., to the tooth T, bone B, and/or other surrounding tissue) via adhesives, sutures, temporary anchorage devices (TADs), one or more bands that extend around the tooth T or neighboring tooth, etc., before the positioner 204 is removed.

The tissue scaffold 202 can promote growth of oral tissue to regenerate missing native tissue at the treatment site. As noted above, the tissue scaffold 202 can include biocompatible materials (e.g., polymers, bioactive agents) that promote cell migration, proliferation, and/or differentiation. In some embodiments, native cells from the different layers of the exposed tissue that are in contact with the tissue scaffold 202 may migrate into the tissue scaffold 202, and may subsequently proliferate and/or differentiate into cell types suitable for regenerating native oral tissue within and/or proximate to the tissue scaffold 202. Optionally, the tissue scaffold 202 may include one or more materials having mechanical properties (e.g., elastic moduli) that mimic the mechanical properties of the native tissues to be regenerated.

Referring next to FIG. 2D, over time, the tissue scaffold 202 may dissolve and be replaced by new oral tissue (e.g., new gingiva G, bone B, cementum C, and/or ligaments L). In some embodiments, 1 mm or more of gingival tissue is restored. The dissolution rate of the tissue scaffold 202 can be selected to match the rate of tissue regeneration for effective integration of new tissue with existing native tissue and/or to ensure proper healing of the treatment site.

### A. Positioners

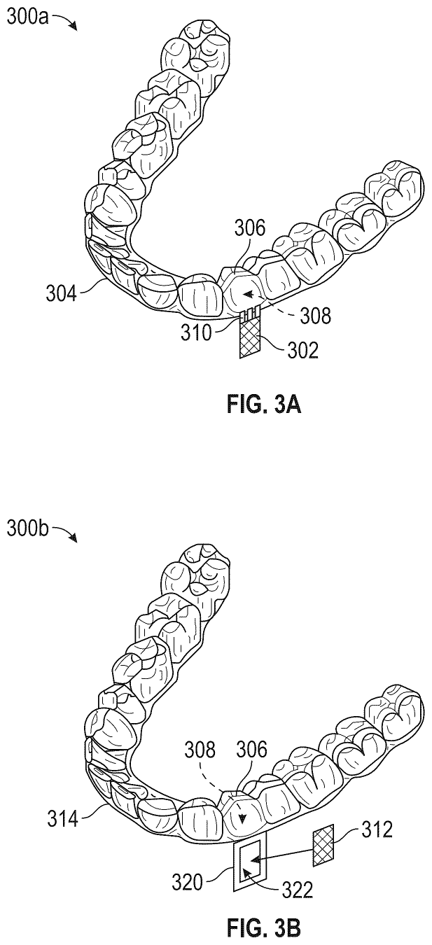

FIG. 3A illustrates a perspective view of a device 300a including a tissue scaffold 302 and a positioner 304, in accordance with embodiments of the present technology. The device 300a can be used to treat an intraoral cavity of a patient, e.g., by regenerating oral tissue at a treatment site as previously discussed with respect to FIGS. 2A-2D.

The tissue scaffold 302 is configured to be positioned at a treatment site within the intraoral cavity to facilitate the growth of oral tissue. The tissue scaffold 302 may be made from one or more polymers that can be biodegradable or non-biodegradable (e.g., aliphatic polyester, polyanhydride, polyphosphazene, poly(ethylene glycol)). In some embodiments, the tissue scaffold 302 incorporates one or more bioactive agents, such as growth factors, inorganic minerals, small molecule drugs, or cells to aid in tissue regeneration. Additional details of the tissue scaffold 302 are provided in Section I.B below.

The positioner 304 is configured to temporarily couple to the tissue scaffold 302 to position the tissue scaffold 302 at the treatment site. In the illustrated embodiment, the positioner 304 includes a shell 306 (e.g., a polymeric shell) having a plurality of cavities 308 configured to receive one or more of the patient's teeth. In some embodiments, the shell 306 receives all of the teeth of the upper or lower jaw. Alternatively, the shell 306 may receive only some of the teeth of the upper or lower jaw, such as only the teeth proximate to the treatment site (e.g., teeth on the same side and/or within the same quadrant as the treatment site). Optionally, the shell 306 may receive only a single tooth, such as the tooth immediately adjacent to the treatment site. The shell 306 can be composed of one or more layers of polymeric material, and may be produced via additive manufacturing, thermoforming, etc., as discussed in Section I.C below.

The cavities 308 of the shell 306 are configured to conform to the surfaces of the received teeth (e.g., the occlusal, lingual, and/or buccal surfaces). For instance, the geometries of the cavities 308 can be designed based on scan data and/or other digital representations of the teeth. In some embodiments, the cavities 308 are configured to fit onto the teeth without exerting repositioning forces on the teeth.

The positioner 304 can be coupled to the tissue scaffold 302 through one or more alignment elements 310. In some embodiments, the positioner 304 and the tissue scaffold 302 are integrally formed with each other as a single unitary component, with the tissue scaffold 302 being connected to the positioner 304 via the alignment elements 310. Alternatively, the positioner 304 and the tissue scaffold 302 may be two discrete components that are subsequently coupled to each other, e.g., by attaching the tissue scaffold 302 to the alignment elements 310 via adhesives, fasteners, bonding, welding, mechanical fit (e.g., interference fit, snap fit), etc.

In the illustrated embodiment, the alignment elements 310 include one or more struts (or similar elongate elements) coupling the tissue scaffold 302 to the shell 306. The geometry (e.g., size, shape) and location of the struts may be selected to position the tissue scaffold 302 at the treatment site when the positioner 304 is worn on the teeth. For example, the struts may be located at or near the gingival edge of the shell 306 so that the tissue scaffold 302 is adjacent to the gingiva when the shell 306 is fitted onto the teeth. The number, geometry (e.g., length, diameter, spacing), and/or location of these struts can be varied as desired, e.g., based on the specific geometry and location of the treatment site as well as the shape of the tissue scaffold 302. For instance, although FIG. 3A illustrates three struts connecting the tissue scaffold 302 to the shell 306, this is not intended to be limiting, and any suitable number of struts can be used (e.g., one, two, four, five, or more). Moreover, although the struts are depicted as connecting to the upper edge of the tissue scaffold 302, some or all of the struts may connect to other portions of the tissue scaffold 302, such as a lateral edge, bottom edge, etc.

In some embodiments, the alignment elements 310 are configured to be releasably coupled to the tissue scaffold 302, thus allowing the tissue scaffold 302 to be separated from the positioner 304 once placed at the treatment site. In the illustrated example, for example, the struts are configured to break to release the tissue scaffold 302. The struts may be weakened (e.g., through narrowing and/or perforations near their connection to the tissue scaffold 302) to allow for controlled fracturing of the struts and/or to reduce residue remaining on the tissue scaffold 302. This breaking of the struts can be performed manually, optionally with aid of a tool. Alternatively or in combination, the breaking may also be facilitated by applying energy (e.g., heat, light) to weaken the struts. In some embodiments, other release techniques may be used, such as decoupling a fastener that couples the tissue scaffold 302 to the struts, melting the struts, dissolving the struts, etc.

FIG. 3B illustrates a perspective view of a device 300b including a tissue scaffold 312 and a positioner 314, in accordance with embodiments of the present technology. The device 300b can be used to treat an intraoral cavity of a patient, e.g., by regenerating oral tissue at a treatment site as previously discussed with respect to FIGS. 2A-2D.

The tissue scaffold 312 is configured to be positioned at a treatment site within the intraoral cavity to facilitate the growth of oral tissue, and may be identical or generally similar to the tissue scaffold 302 of FIG. 3A. Additional details of the tissue scaffold 312 are provided in Section I.B below.

The positioner 314 is configured to temporarily couple to the tissue scaffold 312 to position the tissue scaffold 312 at the treatment site. The positioner 314 may be generally similar to the positioner 304 of FIG. 3A. For instance, the positioner 304 can include a shell 306 (e.g., a polymeric shell) having a plurality of cavities 308 configured to receive one or more of the patient's teeth.

The positioner 314 can be temporarily coupled to the tissue scaffold 312 via one or more alignment elements 320. In the illustrated embodiment, the alignment element 320 is a frame (or similar guide element) including an opening 322 (e.g., a hole, groove, channel, slot) that accommodates at least a portion of the tissue scaffold 312 therein. The geometry of the opening 322 can conform to the geometry of the tissue scaffold 312, e.g., the size and/or shape of the opening 322 can be substantially the same as the size and/or shape of the received portion of the tissue scaffold 312, with sufficient clearance to allow easy insertion/removal of the tissue scaffold 312 into/out of the opening 322. In some embodiments, the opening 322 is configured to receive the entirety of the tissue scaffold 312 (e.g., the frame extends around the entire perimeter of the tissue scaffold 312). Alternatively, the opening 322 may receive only a portion of the tissue scaffold 312 (e.g., the frame extends around only a portion of the perimeter of the tissue scaffold 312, such as the upper portion only).

The geometry and location of the frame can be configured such that, when the positioner 314 is worn on teeth and the tissue scaffold 312 is inserted into the opening 322 of the frame, the tissue scaffold 312 is located at the treatment site. For example, the frame may be located at or near the gingival edge of the shell 306, such that the tissue scaffold 312 is adjacent to the gingiva when positioned into the opening 322.

The configuration of the alignment element 320 shown in FIG. 3B provides a releasable coupling to the tissue scaffold 312, thus allowing the tissue scaffold 312 to be separated from the positioner 314 once placed at the treatment site. Specifically, the positioner 314 and the tissue scaffold 312 can be discrete components that are temporarily coupled to each other by insertion of the tissue scaffold 312 into the opening 322, thereby allowing for easy separation of the positioner 314 from the tissue scaffold 312 simply by removing the positioner 314 from the teeth. In other embodiments, however, the tissue scaffold 312 may be secured within the opening 322 via adhesives, fasteners, bonding, welding, mechanical fit (e.g., interference fit, snap fit), etc., in which case release of the tissue scaffold 312 may involve fracturing of the frame, decoupling a fastener that couples the tissue scaffold 302 to the frame, melting the frame, dissolving the frame, etc.

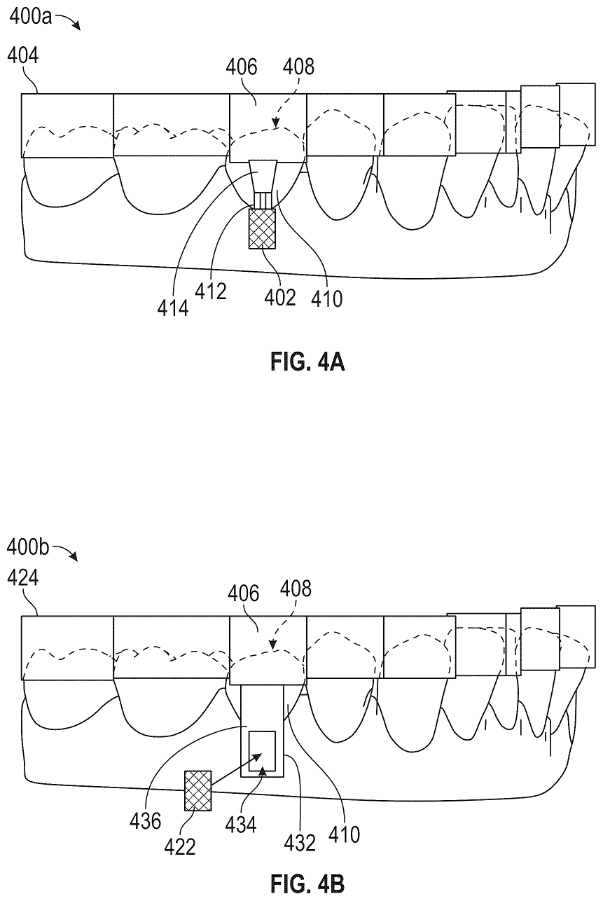

FIG. 4A illustrates a perspective view of a device 400a including a tissue scaffold 402 and a positioner 404, in accordance with embodiments of the present technology. The device 400a can be used to treat an intraoral cavity of a patient, e.g., by regenerating oral tissue at a treatment site as previously discussed with respect to FIGS. 2A-2D.

The tissue scaffold 402 is configured to be positioned at a treatment site within the intraoral cavity to facilitate the growth of oral tissue, and may be identical or generally similar to the tissue scaffold 302 of FIG. 3A. Additional details of the tissue scaffold 402 are provided in Section I.B below.

The positioner 404 is configured to couple temporarily to the tissue scaffold 402 to locate the tissue scaffold 402 at the treatment site. In the illustrated embodiment, the positioner 404 includes one or more registration elements 406 (e.g., anchors) having internal surfaces defining one or more cavities 408 configured to receive one or more teeth 410 of the patient. Unlike the positioner 304 and positioner 314 of FIGS. 3A and 3B, which have external surfaces that generally conform to the shapes of the received teeth, the external surfaces of the registration elements 406 may not match the shapes of the teeth, e.g., the registration elements 406 may be blocks or similar structures having a simplified external surface topography (e.g., for ease of fabrication).

Each registration element 406 may receive a corresponding individual tooth 410. The registration elements 406 may be each configured to receive only a portion of the received tooth 410, such as only the occlusal portion, buccal portion, and/or lingual portion of the tooth 410. For instance, in the illustrated embodiment, the registration elements 406 cover the crowns of the teeth 410 with relatively little coverage of the buccal and lingual surfaces, such that there is a gap between the registration elements 406 and the gingival margin of the teeth 410. In other embodiments, however, the registration elements 406 may have greater tooth coverage, e.g., the gap between the registration elements 406 and the gingival margin may be reduced or even eliminated.

In some embodiments, the positioner 404 includes a plurality of registration elements 406 to receive all of the teeth of the upper or lower jaw. Alternatively, the positioner 404 may include a plurality of registration elements 406 to receive only certain teeth of the upper or lower jaw (e.g., the teeth proximate to the treatment site, such as teeth on the same side and/or within the same quadrant as the treatment site). In embodiments where the positioner 404 includes multiple registration elements 406, the registration elements 406 can be interconnected with each other (e.g., via flexible or rigid couplings) to form a single unitary component. Alternatively, the positioner 404 may include only a single registration element 406 that receives only a single tooth 410 (e.g., the tooth immediately adjacent to the treatment site). The registration elements 406 may be made from one or more layers of polymeric material and may be produced via additive manufacturing or thermoforming and are discussed further in Section I.C.

The cavities 408 of the registration elements 406 are configured to conform to the surfaces of the received teeth 410 (e.g., the occlusal surfaces only, or also the lingual and/or buccal surfaces). In some embodiments, the geometries of the cavities 408 are designed based on scan data and/or other digital representations of the teeth. The cavities 408 may fit onto the teeth 410 without exerting repositioning forces on the teeth.

The positioner 404 can be coupled to the tissue scaffold 402 through one or more alignment elements 412. In some embodiments, the positioner 404 and the tissue scaffold 402 are integrally formed with each other as a single unitary component, with the tissue scaffold 402 being connected to the positioner 404 via the alignment elements 412. Alternatively, the positioner 404 and the tissue scaffold 402 may be two discrete components that are subsequently coupled to each other, e.g., by attaching the tissue scaffold 402 to the alignment elements 412 via adhesives, fasteners, bonding, welding, mechanical fit (e.g., interference fit, snap fit), etc.

In the illustrated embodiment, the alignment elements 412 include one or more struts (or similar elongate elements) coupling the tissue scaffold 402 to the registration element 406 (which may be identical or generally similar to the alignment elements 310 of FIG. 3A). The geometry (e.g., size, shape) and location of the struts may be selected to position the tissue scaffold 402 at the treatment site when the positioner 404 is worn on the teeth. For example, the struts may be located at or near the gingival edge of the registration element 406 so that the tissue scaffold 402 is adjacent to the gingiva when the registration element 406 is fitted onto the teeth. Optionally, in embodiments where there is a relatively large gap between the gingival edge of the registration element 406 and the gingival margin, an extension 414 (e.g., a bridge) may be positioned between the registration element 406 and the struts.

The number, geometry (e.g., length, diameter, spacing), and/or location of the struts can be varied as desired, e.g., based on the specific geometry and location of the treatment site as well as the shape of the tissue scaffold 402. For instance, although FIG. 4A illustrates two struts connecting the tissue scaffold 402 to the registration element 406, this is not intended to be limiting, and any suitable number of struts can be used (e.g., one, three, four, five, or more). Moreover, although the struts are depicted as connecting to the upper edge of the tissue scaffold 402, some or all of the struts may connect to other portions of the tissue scaffold 402, such as a lateral edge, bottom edge, etc.

In some embodiments, the alignment elements 412 are configured to be releasably coupled to the tissue scaffold 402, thus allowing the tissue scaffold 402 to be separated from the positioner 404 once placed at the treatment site. In the illustrated example, for example, the struts are configured to break to release the tissue scaffold 402. The struts may be weakened (e.g., through narrowing and/or perforations near their connection to the tissue scaffold 402) to allow for controlled fracturing of the struts and/or to reduce unwanted residue on the tissue scaffold 402. This breaking of the struts can be performed manually, optionally with aid of a tool. Alternatively or in combination, the breaking may also be facilitated by applying energy (e.g., heat, light) to weaken the struts. In some embodiments, other release techniques may be used, such as decoupling a fastener that couples the tissue scaffold 402 to the struts, melting the struts, dissolving the struts, etc.

FIG. 4B illustrates a perspective view of a device 400b including a tissue scaffold 422 and a positioner 424, in accordance with embodiments of the present technology. The device 400b can be used to treat an intraoral cavity of a patient, e.g., by regenerating oral tissue at a treatment site as previously discussed with respect to FIGS. 2A-2D.

The tissue scaffold 422 is configured to be positioned at a treatment site within the intraoral cavity to facilitate the growth of oral tissue, and may be identical or generally similar to the tissue scaffold 302 of FIG. 3A. Additional details of the tissue scaffold 422 are provided in Section I.B below.

The positioner 424 is configured to temporarily couple to the tissue scaffold 422 to position the tissue scaffold 422 at the treatment site. The positioner 424 may be generally similar to the positioner 404 of FIG. 4A. For instance, the positioner 424 can include one or more registration elements 406 having cavities 408 configured to receive one or more of the patient's teeth.

The positioner 424 can be temporarily coupled to the tissue scaffold 422 via one or more alignment elements 432 (which may be identical or generally similar to the alignment elements 320 of FIG. 3B). In the illustrated embodiment, the alignment element 432 is a frame (or similar guide element) including an opening 434 that accommodates at least a portion of the tissue scaffold 422 therein. The opening 434 may be a hole that extends completely through the thickness of the frame. Alternatively, the opening 434 may be a pocket that extends only partially through the thickness of the frame, in which case the frame may partially or fully cover the tissue scaffold 422. The geometry of the opening 434 can conform to the geometry of the tissue scaffold 422, e.g., the size and/or shape of the opening 434 can be substantially the same as the size and/or shape of the received portion of the tissue scaffold 422, with sufficient clearance to allow easy insertion/removal of the tissue scaffold 422 into/out of the opening 434. In some embodiments, the opening 434 is configured to receive the entirety of the tissue scaffold 422 (e.g., the frame extends around the entire perimeter of the tissue scaffold 422). Alternatively, the opening 434 may receive only a portion of the tissue scaffold 422 (e.g., the frame extends around only a portion of the perimeter of the tissue scaffold 422, such as the upper portion only).

The geometry and location of the frame can be configured such that, when the positioner 424 is worn on teeth and the tissue scaffold 422 is inserted into the opening 434 of the frame, the tissue scaffold 422 is located at the treatment site. For example, the frame may be located at or near the gingival edge of the registration element 406, such that the tissue scaffold 422 is adjacent to the gingiva when positioned into the opening 434. Optionally, in embodiments where there is a relatively large gap between the gingival edge of the registration element 406 and the gingival margin, an extension 436 (e.g., a bridge) may be positioned between the registration element 406 and the frame.

The configuration of the alignment element 432 shown in FIG. 4B provides a releasable coupling to the tissue scaffold 422, thus allowing the tissue scaffold 422 to be separated from the positioner 424 once placed at the treatment site. Specifically, the positioner 424 and the tissue scaffold 422 can be discrete components that are temporarily coupled to each other by insertion of the tissue scaffold 422 into the opening 434, thereby allowing for easy separation of the positioner 424 from the tissue scaffold 422 simply by removing the positioner 424 from the teeth. In other embodiments, however, the tissue scaffold 422 may be secured within the opening 434 via adhesives, fasteners, bonding, welding, mechanical fit (e.g., interference fit, snap fit), etc., in which case release of the tissue scaffold 422 may involve fracturing of the frame, decoupling a fastener that couples the tissue scaffold 422 to the frame, melting the frame, dissolving the frame, etc.

Although FIGS. 3A-4B illustrate positioners for locating a single tissue scaffold at a single treatment site in an intraoral cavity, the positioners herein can be configured to concurrently locate multiple tissue scaffolds at multiple treatment sites, such as two, three, four, five, or more tissue scaffolds for placement at two, three, four, five, or more different treatment sites. Moreover, although FIGS. 3A-4B illustrate positioners that locate a tissue scaffold at a buccal treatment site of a patient's dental arch, the positioners herein may alternatively or additionally be used for locating tissue scaffolds at other locations, such as lingual treatment site, palatal treatment site, etc. The number and location of the alignment elements with respect to the positioner can be adjusted based on the number of tissue scaffolds and the locations of the treatment sites.

Moreover, the positioners described herein can include other features, in addition or as an alternative to the features illustrated in FIGS. 3A-4B. For example, a positioner may include a body having a surface shaped to conform to the contours of at least one exterior surface of a tooth, and at least one pocket or aperture formed in the body for holding and locating a tissue scaffold at a treatment The pocket/aperture may extend around the entire perimeter of the tissue scaffold, or may extend only partially around the perimeter of the tissue scaffold. The tissue scaffold may be fabricated separately from the positioner and may be placed in the pocket/aperture at the time of use.

As another example, a positioner may include a body having a surface shaped to conform to the contours of at least one exterior surface of a tooth, and at least one scaffold mounting structure formed in the body for holding and locating a tissue scaffold at a treatment site, where the scaffold mounting structure is coupled to the tissue scaffold via one or more supports (e.g., breakable struts). The supports may be arranged in any suitable configuration relative to the tissue scaffold, such as radially around the tissue scaffold, at one side of the tissue scaffold, etc. The supports may have any suitable geometry, such as straight, curved, curvilinear, etc. The supports may be narrowed, perforated, thinned, or otherwise weakened at or near the connection point to the tissue scaffold to facilitate breaking at the connection point to release the tissue scaffold. Optionally, the scaffold mounting structure may include a frame extending partially or entirely around the tissue scaffold, where the one or more supports connect the tissue scaffold to the frame. The frame may be used to protect the supports and/or tissue scaffold during manufacturing and handling to avoid inadvertent breakage or other damage.

In a further example, one or more portions of the positioner may be flexible in order to reduce stress concentrations in portions of the structure. Since the positioner may be made of brittle material (e.g., some composite materials), such flexible features can allow the positioner to be more resilient and less prone to breakage while still being made of material(s) having desirable properties such as stiffness. The flexible features can reduce the occurrence of breakage during handling (e.g., during manufacture and shipping) of the structure. Having flexible features may allow more positioners to be printed (e.g., on a build plate) per additive manufacturing operation. The flexible features may also allow the positioner to bend in ways that reduce the dimensions of the positioner for more efficient packaging. The flexible features may also provide some tolerance so that the positioner can fit on the patient's dental arch more easily. For example, the body of the positioner itself may be flexible, e.g., made of a flexible material and/or having a flexible shape (e.g., zig-zag shape, sinusoidal shape), or may include couplings (e.g., interlocking links, pivotable joints) that provide flexibility. Alternatively or in combination, the scaffold mounting structure may be flexible, e.g., made of a flexible material and/or having a flexible shape. A flexible scaffold mounting structure may also allow for more maneuverability of the tissue scaffold by the clinician during placement and affixing of the tissue scaffold to the treatment site.

Additional features that may be incorporated into the positioners described herein are provided in U.S. Patent Application Publication No. 2024/0016579, the disclosure of which is incorporate by reference herein in its entirety.

The positioners described herein can be composed of one or more materials. The positioner material can be biocompatible (e.g., suitable for placement in an intraoral cavity). The positioner material may or may not be biodegradable. The positioner material may or may not be transparent or translucent, depending on aesthetic and/or functional requirements. In some embodiments, the positioner material is the same as the tissue scaffold material of the tissue scaffold. In other embodiments, the positioner material is different from the tissue scaffold material.

In some embodiments, the positioner material includes at least one polymer. The polymer can be a synthetic polymer, a naturally-occurring polymer, or a combination (e.g., a copolymer or a mixture) thereof. The polymer can be a thermoset polymer, a thermoplastic polymer, or a combination thereof. The polymer may or may not be crosslinked.

In some embodiments, the polymer is prepared from a resin including one or more polymerizable components, such as one or more monomers, oligomers, and/or reactive polymers. The polymerizable components can be any molecule or compound capable of forming bonds with other polymerizable components, thus resulting in a larger molecule with increased molecular weight. In some embodiments, the bond-forming reaction occurs multiple times, such that the molecular weight of the resultant molecule increases with each successive bond-forming reaction. Examples of bond-forming reactions suitable for use with the techniques described herein include, but are not limited to, free radical polymerization, ionic polymerization (e.g., cationic polymerization, anionic polymerization), condensation polymerization, metathesis polymerization, ring opening polymerization, Diels-Alder reactions, photodimerization, carbene formation, nitrene formation, acetal formation, and suitable combinations thereof.

In some embodiments, the polymerizable components include one or more of the following: an acrylate monomer, a methacrylate monomer, a thiol monomer, a vinyl acetate monomer, a vinyl ether monomer, a vinyl chloride monomer, a vinyl silane monomer, a vinyl siloxane monomer, a styrene monomer, an allyl ether monomer, an alkylene monomer, an acrylonitrile monomer, a butadiene monomer, a norbornene monomer, a maleate monomer, a fumarate monomer, an epoxide monomer, an anhydride monomer, a cyclic ether monomer, a cyclic ester monomer, a cyclic carbonate monomer, a cyclic carbamate monomer, an ester monomer, an amide monomer, a carbonate monomer, a carboxylic acid monomer, an amine monomer, or a hydroxyl monomer. In some embodiments, the polymerizable components include one or more of the following: a free radically polymerizable group, a cationically polymerizable group, or an anionically polymerizable group. In some embodiments, the polymerizable components include one or more reactive functional groups, such as one or more of the following: an acrylate, a methacrylate, an acrylamide, a vinyl group, a vinyl ether, a thiol, an allyl ether, a vinyl silane, an allyl silane, a norbornene, a vinyl acetate, a maleate, a fumarate, a methylenemalonate, a maleimide, an epoxide, a ring-strained cyclic ether, a ring-strained thioether, a cyclic ester, a cyclic carbonate, a cyclic silane, a cyclic siloxane, a hydroxyl, an amine, an isocyanate, a blocked isocyanate, a carboxylic acid, an acid chloride, an activated ester, an oxetane, a Diels-Alder reactive group, a furan, a cyclopentadiene, an anhydride, a group favorable toward photodimerization (e.g., an anthracene, an acenaphthylene, or a coumarin), a group that photodegrades into a reactive species (e.g., Norrish Type 1 and 2 materials), an azide, a derivative thereof, or a combination thereof. Additional examples of polymerizable components that may be used are provided in U.S. Pat. No. 10,495,973 and U.S. Patent Publication Nos. 2021/0147672, 2021/0395420, 2022/0380502, and 2023/0021953, the disclosures of each of which are incorporated by reference herein in their entirety.

The positioner material can be selected to be compatible with the manufacturing process for the positioner. For example, the positioner material can be an additively manufactured material suitable for use with an additive manufacturing process (e.g., stereolithography, digital light processing, powder bed fusion, fused deposition modeling). As another example, the positioner material can be a thermoformable material suitable for use in a thermoforming process. In a further example, the positioner material can be suitable for other types of manufacturing processes, such as a stamping process, a rolling process, a casting process, a lamination process, an injection molding process, a blow molding process, a deposition process, a milling process, a pressure forming process, etc.

The positioner material can be selected to have mechanical properties that are suitable for the function of the positioner. For example, the positioner material can be sufficiently tough and flexible to be placed on a patient's dentition without breaking. In some embodiments, the positioner material transfers stress applied to the positioner to the tissue scaffold so that the tissue scaffold presses up against the tissue to be grown (e.g., gum tissue). Moreover, in embodiments where the tissue scaffold is connected to the positioner via struts, the struts connected to a surface of the tissue scaffold that is opposite the surface that contacts the tissue, such that downward pressure can be applied to the tissue scaffold via the struts to help hold the scaffold against the tissue. A similar effect can be achieved using a pocket that covers the surface of the tissue scaffold opposite the surface that contacts the tissue. The positioner material can be configured to break away from the tissue scaffold after the tissue scaffold has been properly located and/or attached to the treatment site.

In some embodiments, the positioner is a single use disposable that is discarded after use. In some embodiments, the positioner is left in place on the dentition for some time before removal to ensure the tissue scaffold is properly held in place (e.g., 1 min, 5 min, 30 min, 1 hour, 2 hours, 1 day, 2 days, 1 week, 2 weeks, 1 month, 2 months, or more). In some embodiments, the positioner is biodegradable and therefore does not need to be removed (e.g., the positioner can have a degradation rate of 5 min, 30 min, 1 hour, 2 hours, 1 day, 2 days, 1 week, 2 weeks, 1 month, 2 months, or more).

### B. Tissue Scaffold

The tissue scaffold can be fabricated from one or more biomaterials, such as materials that promote growth of oral tissues. Examples of oral tissues that may be regenerated using the tissue scaffold include gingiva (e.g., gingival epithelium, gingival connective tissue), ligaments (e.g., PDL), cementum, and/or bone (e.g., alveolar bone). Control over tissue growth can be achieved based on the type of materials used in the tissue scaffold, chemical composition, biological composition (e.g., presence of growth and/or differentiation factors), mechanical properties (e.g., modulus), 3D structure (e.g., thickness, porosity) and/or the degradation rate of the tissue scaffold. In some embodiments, the tissue scaffold is configured to provide environmental cues (e.g., physical, chemical, and/or biological cues) that are tailored for regeneration of specific oral tissues, e.g., by promoting cell adhesion, migration, proliferation, differentiation, and/or immunomodulation. For instance, the tissue scaffold can promote proliferation and differentiation of encapsulated and/or infiltrating stem cells into more complex tissue based on the environmental cues provided by the tissue scaffold.

In some embodiments, the tissue scaffold is composed of a biodegradable material. Alternatively, the tissue scaffold can be composed of a non-biodegradable material. Optionally a combination of biodegradable and non-biodegradable materials can be used.

In some embodiments, the tissue scaffold material includes at least one polymer. The polymer can be a synthetic polymer, a naturally-occurring polymer, or a combination (e.g., a copolymer or a mixture) thereof. The polymer can be a thermoset polymer, a thermoplastic polymer, or a combination thereof. The polymer may or may not be crosslinked. In some embodiments, the polymer is prepared from a resin including one or more polymerizable components, such as any of the embodiments described in Section I.A above.

The polymer may be a biocompatible polymer. Examples of biocompatible polymers include agarose, cellulose and derivatives thereof (e.g., carboxymethyl cellulose, hydroxyethyl cellulose), chitosan, gelatin, protein, alginate, hyaluronic acid, pectin, poly(2-hydroxyethyl methacrylate) (pHEMA), polyacrylamide, polyurethane, poly(vinyl alcohol) (PVA), poly(ethylene glycol) (PEG), polystyrene, polyvinylpyrrolidone (PVP), poly(lactic-co-glycolic acid) (PLGA), starch, and combinations (e.g., copolymers, mixtures) thereof. In some embodiments, the polymer is an aliphatic polyester, a polyanhydride, a polyphosphazene, or a poly(ethylene glycol) (PEG). Examples of aliphatic polyesters include poly(lactide), poly(glycolide), poly(caprolactone), poly(lactide-co-glycolide) (PLGA), poly(lactide-co-caprolactone), and poly(glycolide-co-caprolactone). Combinations (e.g., copolymers, mixtures) and derivatives of any of the above polymers may also be used.

In some embodiments, the tissue scaffold is composed of one or more polymers that form a hydrogel. The hydrogel can encapsulate one or more bioactive agents that promote growth of oral tissue, as discussed further below. For example, hydrogels encapsulating hydroxyapatite may be used to regrow bone tissue.

The tissue scaffold material can be selected to be compatible with the manufacturing process for the tissue scaffold. For example, the tissue scaffold material can be an additively manufactured material suitable for use with an additive manufacturing process (e.g., stereolithography, digital light processing, powder bed fusion, fused deposition modeling, volumetric printing). As another example, the tissue scaffold material can be a thermoformable material suitable for use in a thermoforming process. In a further example, the tissue scaffold material can be suitable for other types of manufacturing processes, such as a stamping process, a rolling process, a casting process, a lamination process, an injection molding process, a blow molding process, a deposition process, a milling process, a pressure forming process, etc.

In some embodiments, the tissue scaffold includes at least one bioactive agent, such as a growth factor, an inorganic mineral, a small molecule drug, a cell, an antibiotic compound, an antifungal compound, an antiviral compound, etc. The bioactive agent can be selected to promote cell adhesion, migration, proliferation, differentiation, and/or immunomodulation. One or more bioactive agents may be incorporated into the bulk of the tissue scaffold material (e.g., mixed with or otherwise encapsulated by the polymer), applied onto the surface of the tissue scaffold material (e.g., as part of one or more coatings), or a combination thereof.

In some embodiments, the bioactive agent includes at least one growth factor, e.g., to promote growth of one or more oral tissue types. Examples of growth factors include bone morphogenic protein (BMP) (e.g., BMP-2, BMP-7), fibroblast growth factor (FGF), insulin-like growth factor I (IGF-I), insulin-like growth factor II (IGF-II), platelet derived growth factor (PDGF), stromal cell-derived factor 1 (SDF-1), transforming growth factor beta (TGF-β), and vascular endothelial growth factor (VEGF).

In some embodiments, the bioactive agent includes at least one inorganic mineral, e.g., to promote bone regeneration. Examples of inorganic minerals include hydroxyapatite, calcium phosphate, calcium sulfate, sulfur, calcium carbonate, and bioactive glass.

In some embodiments, the bioactive agent includes a small molecule drug. Examples of small molecule drugs include statins (e.g., simvastatin, atorvastatin) and metformin.

In some embodiments, the bioactive agent includes at least one cell. Examples of cells include stem cells, such as mesenchymal stem cells (MSCs) (e.g., bone marrow derived mesenchymal stem cells (BMSCs)), adipose-derived stem cells (ADSCs), periodontal ligament stem cells (PDLSCs), and dental pulp stem cells (DSPCs)). The cells may be pre-seeded into the tissue scaffold before implantation. Such cells can be grown in vitro and can include cells from the patient or from another source (e.g., a donor). For example, the oral environment contains several classes of stem cells that can be easily gathered, such as MSCs. Cells may be collected from the patient or a donor via small tissue sampling, inner cheek scraping, or other methods of tissue collection known to those of skill in the art.

In some embodiments, the tissue scaffold includes at least one material that provides a desired set of mechanical properties. For example, the tissue scaffold can include a single material having a single modulus (e.g., elastic modulus). Alternatively, the tissue scaffold can include two or more materials having different moduli. In such embodiments, different portions of the tissue scaffold may have different moduli, e.g., to match the modulus of the tissue type to be regrown and/or replaced. In some embodiments, the tissue scaffold has portions (e.g., layers) with different moduli corresponding to different tissues of the oral cavity, such as bone, cartilage, ligament, arteries, veins, skin, cartilage, pulp, dentin, enamel, etc. For example, the tissue scaffold can include a first portion composed of a first material (e.g., to promote growth of soft tissue) and a second portion composed of a second, different material (e.g., to promote growth of bone tissue). Portions for bone regrowth may have a higher modulus (e.g., a modulus greater than 100 kPa), while portions for soft tissue regrowth can have a lower modulus (e.g., a modulus within a range from 1 kPa to 20 kPa).

In some embodiments, directed tissue regeneration techniques are used, such as directed bone regeneration techniques. In such embodiments, a biodegradable or non-biodegradable membrane may be used to separate portions of the tissue scaffold for bone growth from the remaining portions of the tissue scaffold. The membrane can be part of the tissue scaffold, or can be attached to the tissue scaffold after fabrication of the tissue scaffold. In some embodiments, the tissue scaffold and/or the membrane are additively manufactured (e.g., via multi-material techniques).

The tissue scaffold can have any suitable form factor, such as a block, rod, plug, capsule, film, mesh, etc. The shape of the tissue scaffold can be configured to conform to the patient's current tissue boundaries (e.g., to match the current treatment site) and/or to correspond the volume of tissue to be regrown. For instance, the tissue scaffold can form a tight seal against tissue at the treatment site to reduce the likelihood of infection. Optionally, the tissue scaffold may include anchoring features to secure the tissue scaffold to the treatment site, e.g., the tissue scaffold may be shaped to clamp onto bone, teeth, or other tissue. In some embodiments, the color of the tissue scaffold substantially matches the color of the tissue to be grown and/or replaced.

In some embodiments, the tissue scaffold is a hollow structure, such as a porous and/or mesh structure. The pore/mesh size can be selected to facilitate cell infiltration and/or tissue ingrowth (e.g., ingrowth of blood vessels). For example, the pore/mesh size (e.g., diameter) can be within a range from 1 μm to 1 mm, 1 μm to 500 μm, 1 μm to 200 μm, 1 μm to 100 μm, 1 μm to 50 μm, 1 μm to 20 μm, 1 μm to 10 μm, 10 μm to 1 mm, 10 μm to 500 μm, 10 μm to 200 μm, 10 μm to 100 μm, 10 μm to 50 μm, 10 μm to 20 μm, 20 μm to 1 mm, 20 μm to 500 μm, 20 μm to 200 μm, 20 μm to 100 μm, 20 μm to 50 μm, 50 μm to 1 mm, 50 μm to 500 μm, 50 μm to 200 μm, 50 μm to 100 μm, 100 μm to 1 mm, 100 μm to 500 μm, 100 μm to 200 μm, 200 μm to 1 mm, 200 μm to 500 μm, or 500 μm to 1 mm.

In some embodiments, the tissue scaffold includes one or more areas that dissolve in vivo to form channels having a size to facilitate cell infiltration and/or tissue ingrowth, such as any of the size ranges described above. Such channels can be created, for example, by incorporation of chopped fibers of the desired diameter in the scaffold material at concentrations that promote connectivity of the fibers. The length of the fibers can also be selected to provide a desired degree of connectivity, e.g., long fibers may promote more connectivity than short fibers. The fibers can be composed of low-crosslinking to non-crosslinked materials that have dissolution rates of minutes, hours, or days.

Alternatively, the tissue scaffold may be created with channels by additive manufacturing processes that control the formation of crosslinks, such as grayscale irradiation techniques. Channels can also be formed during additive manufacturing by not curing the volume of material corresponding to the channels. The uncured material may be left in place, removed, and/or replaced by other materials after the additive manufacturing process. The channels may also be formed in place by additive manufacturing processes such as multi-material additive manufacturing, inkjet printing, direct ink writing, volumetric additive manufacturing, and/or other additive manufacturing and/or hybrid printing processes that support multiple materials.

In some embodiments, the tissue scaffold has surface features that are configured to pierce into the tissue at the treatment site (e.g., the gingival epithelium). Such surface features can include spikes, sharp edges, micro-needles, high surface roughness, etc., that puncture, abrade, cut, or otherwise penetrate into the tissue that is in contact with the tissue scaffold. The piercing of the tissue can allow native cells and/or physiological fluids to infiltrate into the tissue scaffold (e.g., into the pores and/or channels in the tissue scaffold), which may serve as an in situ seeding process in which live cells present in the tissue are immediately placed inside the tissue scaffold to increase the rate of tissue regeneration throughout the tissue scaffold, as opposed to just the areas of contact with the gingiva. Moreover, the piercing of the tissue can elicit a local inflammatory and/or healing response to promote tissue regeneration, e.g., via the regional acceleratory phenomenon (RAP).

In some embodiments, an adhesive is provided on the tissue scaffold for attaching to tissue at the treatment site, e.g., to a tooth and/or bone. The adhesive may be applied to the tissue scaffold by the manufacturer of the tissue scaffold or by the clinician, before placement of the tissue scaffold at the treatment site. Alternatively or in combination, the adhesive may be applied to the treatment site before placement of the tissue scaffold. The adhesive may be any biocompatible adhesive, and may be biodegradable or non-biodegradable. Examples of adhesives that may be used include bone adhesives (e.g., Tetranite®), dental adhesives (e.g., glass ionomer cement, resin-modified glass ionomers, zinc oxide eugenol, polycarboxylate cement, bioactive resin adhesives (e.g., ACTIVA™ BioACTIVE), self-etch adhesive systems, dental composites), inorganic solid-state adhesives (e.g., adhesives composed of oxide nanoparticles, calcium phosphate nanoparticles, etc.), metallic solid-state adhesives (e.g., adhesives composed of modified titanium such as titanium hydrides), cyanoacrylates (e.g., DERMABOND™, PeriAcryl®), collagen-based adhesives, etc. Optionally, the adhesive itself may serve as a scaffold for tissue growth, such as for growth of bone, cementum and/or the PDL.

Alternatively or in combination, the tissue scaffold may be secured to the treatment site using other techniques. For example, fasteners such as sutures and TADs may be used to attach the tissue scaffold to tissue at the treatment site (e.g., to a tooth, bone, and/or soft tissue). As another example, the tissue scaffold can be coupled to a band that extends partially or entirely around one or more teeth proximate to the treatment site, or in between teeth proximate to the treatment site, to retain the tissue scaffold at the treatment site. In a further example, the tissue scaffold can be configured as a clasp, clamp, spring, or similar element that mechanically couples to tissue at the treatment site (e.g., to a tooth) to secure the tissue scaffold in place.

### C. Associated Methods

The positioners and tissue scaffolds described herein can be fabricated using any suitable method. In some embodiments, the positioner and/or tissue scaffold are additively manufactured, e.g., from the same material or from different materials. The additive manufacturing process can include any of the additive manufacturing techniques described herein, e.g., in Section II below. In some embodiments, the positioner is fabricated via additive manufacturing and the tissue scaffold is fabricated via a different technique. In some embodiments, the tissue scaffold is fabricated via additive manufacturing and the positioner is fabricated via a different technique. Other manufacturing processes (additive and subtractive methods) that may be used for the positioner and/or the tissue scaffold include thermoforming, stamping, rolling, casting, lamination, injection molding, blow molding, deposition, milling, laser cutting, laser ablation, and pressure forming. Combinations of different manufacturing processes can also be used, particularly when the positioner and tissue scaffold are fabricated from multiple materials. In some embodiments, the positioner and the tissue scaffold are fabricated concurrently, such that the positioner and tissue scaffold are integrally formed with each other. In some embodiments, the positioner and the tissue scaffold are fabricated separately, such that the positioner and tissue scaffold are discrete components that are subsequently assembled.

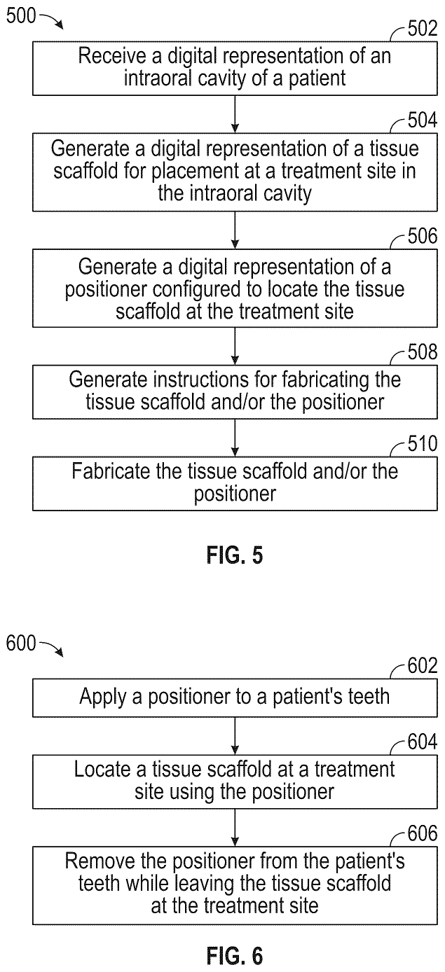

FIG. 5 is a flow diagram illustrating a method 500 for designing and/or fabricating a device for treating a patient's intraoral cavity, in accordance with embodiments of the present technology. The method 500 can be used to design and fabricate any of the positioners and/or tissue scaffolds described herein. In some embodiments, some or all of the processes of the method 500 are implemented as computer-readable instructions (e.g., program code) that are configured to be executed by one or more processors of a computing device, such as a computing device of a treatment planning system, device design system, device fabrication system, or suitable combinations thereof.

The method 500 can begin at block 502, with receiving a digital representation of an intraoral cavity of a patient. The digital representation may be a 3D digital model (e.g., a surface model, a solid model, a mesh model, a parametric model) representing features of the intraoral cavity, such as one or more teeth and/or a treatment site within the intraoral cavity. The digital representation may depict the surface features of the intraoral cavity (e.g., surfaces of teeth and/or gingiva) as well as sub-surface features (e.g., the underlying bone, tooth roots, and/or sub-surface soft tissues). The digital representation can include or based on scan data (e.g., intraoral and/or extraoral scans of the patient's teeth and/or of impressions of the teeth), magnetic resonance imaging (MRI) data, radiographic data (e.g., standard x-ray data such as bitewing x-ray data, panoramic x-ray data, cephalometric x-ray data, computed tomography (CT) data, cone-beam computed tomography (CBCT) data, fluoroscopy data), photographs, video, or any other data type that depicts features of interest of the intraoral cavity. For instance, intraoral scan data may be used to determine surface features, while radiographic data may be used to determine sub-surface features. The use of a digital representation of the intraoral cavity can allow for greater precision and improved patient customization in subsequent design and fabrication processes.

At block 504, the method 500 can include generating a digital representation of a tissue scaffold for placement at a treatment site in the intraoral cavity. In some embodiments, the tissue scaffold is configured to promote growth of oral tissue at the treatment site. The tissue scaffold may include any of the features described herein, e.g., in Section I.B above. For example, the tissue scaffold may be composed of one or more polymers (e.g., an aliphatic polyester, a polyanhydride, a polyphosphazene, a poly(ethylene glycol)) and/or can include one or more bioactive agents (e.g., a growth factor, an inorganic mineral, a small molecule drug, a cell). The tissue scaffold may include a plurality of different materials, optionally with varying moduli to correspond to different types of oral tissues to be regenerated.

The digital representation of the tissue scaffold can be a 3D digital model, a series of 2D images, or any other digital format depicting the geometry of the tissue scaffold. The tissue scaffold may be designed based on the digital representation of the intraoral cavity, e.g., the tissue scaffold can be shaped and sized to fit into the treatment site, and/or may have a geometry corresponding to the target geometry of the tissue to be regrown. For instance, the process of block 504 can include identifying a geometry of the treatment site (e.g., the surfaces of the tissues at the treatment site), and then determining a geometry for the tissue scaffold that is complementary to the treatment site (e.g., the surfaces of the tissue scaffold mate with the tissue surfaces at the treatment site). The size and shape of the tissue scaffold can be determined by the amount of tissue to be regrown, the location of the underlying bone structures (e.g., bone structures that provide the vasculature to support the gum tissue, which may limit the amount of tissue that can be regrown), the desires of the patient, the root-enamel boundary (e.g., for gum tissue regrowth), the pocket size, and/or the number of treatments (e.g., if more than one round of tissue scaffolding is needed for a particular section of the tissue to be regrown).

Optionally, in embodiments where the tissue scaffold includes different portions that correspond to different tissue types at the treatment site (e.g., bone versus soft tissue), the digital representation can include individual digital representations of the different portions. In such embodiments, the geometry and locations of the different portions of the tissue scaffold may be determined based on the geometry and locations of the different tissue types at treatment site, e.g., a portion corresponding to bone tissue may be designed for placement proximate to bone at the treatment site, a portion corresponding to soft tissue may be designed for placement proximate to soft tissue at the treatment site, etc.

The process of block 504 may be performed automatically (e.g., via one or more software programs and/or algorithms), manually (e.g., by a technician), or suitable combinations thereof (e.g., a software program can provide an initial design which is reviewed and/or modified by a user)

At block 506, the method 500 can include generating a digital representation of a positioner configured to locate the tissue scaffold at the treatment site. The positioner may include any of the features described herein, e.g., in Section I.A above. For example, the positioner may include one or more cavities configured to fit on one or more of the patient's teeth. The positioner can include a shell or one or more registration elements having internal (tooth-facing) surfaces that define the one or more cavities. The positioner may also include an alignment element with releasable connections (e.g., breakable struts) and/or openings for temporarily coupling to the tissue scaffold.

The digital representation of the positioner can be a 3D digital model, a series of 2D images, or any other digital format depicting the geometry of the positioner. The tissue scaffold may be designed based on the digital representation of the intraoral cavity and/or the digital representation of the tissue scaffold, e.g., the positioner can be shaped and sized to fit on patient's teeth and to locate the tissue scaffold at the treatment site. For instance, the process of block 506 can include identifying a geometry of one or more of the patient's teeth, based on the digital representation of the intraoral cavity, and then designing the one or more cavities to fit on the teeth. The process can also include identifying a geometry of the tissue scaffold, based on the digital representation of the tissue scaffold, and identifying a location of the treatment site, based on the digital representation of the intraoral cavity. The process can then include designing one or more alignment elements (e.g., releasable connections, openings) to place the tissue scaffold at the location of the treatment site when the positioner is worn on the teeth. In some embodiments, the portion of the positioner that is closest to the treatment site is identified (e.g., the gingival edge of the positioner adjacent to the treatment site), and then the alignment element is added to the portion of the positioner. The shape, size, and/or location of the alignment element can then be selected for correct placement of the tissue scaffold at the treatment site.

The process of block 506 may be performed automatically (e.g., via one or more software programs and/or algorithms), manually (e.g., by a technician), or suitable combinations thereof (e.g., a software program can provide an initial design which is reviewed and/or modified by a user). In some embodiments, the process of block 506 is performed concurrently with the process of block 504, e.g., a single software algorithm generates the digital representation of the tissue scaffold together with the digital representation of the positioner.

At block 508, the method 500 includes generating instructions for fabricating the tissue scaffold and/or the positioner. The instructions can be based on the digital representations of the tissue scaffold and/or the positioner, respectively. The instructions can be any digital data set suitable for controlling the operation of a fabrication system to be used to produce the tissue scaffold and/or the positioner. In some embodiments, for example, the fabrication system is an additive manufacturing system including an energy source (e.g., a laser or light engine) configured to apply energy to a precursor material (e.g., a photopolymerizable resin) to form the positioner and/or the tissue scaffold in a layer-by-layer manner. Other types of fabrication systems may also be used, such as systems for thermoforming, stamping, rolling, casting, lamination, injection molding, blow molding, deposition, milling, pressure forming, etc. The instructions can be provided in any suitable format, such as a toolpath file format (e.g., G-code file format).

At block 510, the method 500 includes fabricating the tissue scaffold and/or the positioner. Fabrication of the tissue scaffold and/or the positioner can be performed using any of the techniques described herein, such as an additive manufacturing process (e.g., as described in Section II below), a subtractive manufacturing process, a thermoforming process, a stamping process, a rolling process, a casting process, a lamination process, an injection molding process, a blow molding process, a deposition process, a milling process, a laser cutting process, a pressure forming process, etc. In some embodiments, the positioner and tissue scaffold are fabricated concurrently in the same manufacturing operation. Alternatively, the positioner and tissue scaffold can be fabricated separately and then assembled prior to use on a patient. In some embodiments, the positioner and/or tissue scaffold may include multiple materials and/or parts that are fabricated separately before assembling into a single positioner and/or tissue scaffold

Optionally, the process of block 510 can include post-processing of the tissue scaffold and/or positioner after fabrication. Post-processing may include, for example, removal of residual material (e.g., solvent washing, centrifuging), additional curing (e.g., via heat treatment, light exposure, inert liquid or gas treatment to reduce oxygen inhibition during curing, and/or other energy input that causes the material to further cure), and/or further material processing (e.g., annealing, thermal aging, small molecule extractions, solvent removal, drying, solvent swelling (e.g., with water)). Optionally, the tissue scaffold and/or positioner can be treated with chemicals, bioactive agents, colors, coatings, sterilizations, growth media, etc.

The method 500 illustrated in FIG. 5 can be modified in many different ways. For example, some of the processes of the method 500 can be omitted, the method 500 can include additional processes not shown in FIG. 5, and/or the order of the processes shown in FIG. 5 can be varied as desired. For example, the method 500 can further include generating a treatment plan (e.g., based on inputs from the clinician and/or patient), where the treatment plan includes the digital representations of the tissue scaffold and/or positioner, the number of treatments, the materials to be used, etc. The treatment plan can be displayed to a user (e.g., the clinician and/or patient) for review and/or modifications. Furthermore, although the above processes of the method 500 are described with respect to a single tissue scaffold and a positioner, the method 500 can be used to generate multiple tissue scaffolds and/or multiple positioners, such as a positioner that locates multiple tissue scaffolds at multiple treatment sites, a series of positioners and tissue scaffolds for regrowing tissue in a plurality of incremental treatment stages, etc.

FIG. 6 is a flow diagram illustrating a method 600 for treating a patient's intraoral cavity, in accordance with embodiments of the present technology. The method can be implemented using any of the positioners and/or tissue scaffolds described herein, e.g., in Sections I.A and I.B above. The method 600 can be used to grow many different types of oral tissues (e.g., gingiva, ligaments, cementum, or bone).

The method 600 can begin at block 602, with applying a positioner to a patient's teeth. The positioner may include one or more cavities configured to receive one or more teeth of the patient. For example, the positioner can be a polymeric shell having the one or more cavities. As another example, the positioner can include one or more registration elements having the one or more cavities.

At block 604, the method 600 can include locating a tissue scaffold at a treatment site using the positioner. For example, the treatment site can be a gum recession site, a periodontitis site, or a bone loss site. The tissue scaffold can be composed of one or more biocompatible materials (e.g., an aliphatic polyester, a polyanhydride, a poly(ethylene glycol)) and/or one or more bioactive agents (e.g., growth factors, inorganic minerals, small molecule drugs) to promote growth of oral tissue at the treatment site, such as by promoting cell migration, proliferation, and differentiation at the treatment site. Optionally, an adhesive can be applied to the tissue scaffold and/or to the treatment site to secure the tissue scaffold to the treatment site.

The tissue scaffold may be located at the treatment site by temporarily coupling the tissue scaffold to an alignment element of the positioner. For instance, the alignment element can be a releasable connection (e.g., breakable struts) that is temporarily attached to the tissue scaffold to locate the tissue scaffold at the treatment site. In such embodiments, the processes of blocks 602 and 604 may be performed concurrently, e.g., placement of the positioner on the teeth results in placement of the tissue scaffold at the treatment site, by virtue of the connection between the positioner and the tissue scaffold. As another example, the alignment element can be a frame including an opening that receives the tissue scaffold to locate the tissue scaffold at the treatment site. In such embodiments, the process of block 604 may be performed after the process of block 602, e.g., the positioner is placed on the teeth, and the tissue scaffold is then inserted into the opening to place the tissue scaffold at the correct location.

At block 606, the method 600 can include removing the positioner from the patient's teeth while leaving the tissue scaffold at the treatment site. The positioner may include releasable connections (e.g., breakable struts) to allow the tissue scaffold to remain in place as the positioner is removed. The physical, chemical, and/or biological cues provided by the tissue scaffold can then promote regrowth of oral tissue around and/or within the tissue scaffold over time.

The method 600 illustrated in FIG. 6 can be modified in many different ways. For example, some of the processes of the method 600 can be omitted, the method 600 can include additional processes not shown in FIG. 6, and/or the order of the processes shown in FIG. 6 can be varied as desired. For instance, although the above processes of the method 600 are described with respect to a single tissue scaffold and a positioner, the method 600 can be used to place multiple tissue scaffolds using a single positioner, the method 600 may be repeated to place multiple tissue scaffolds at the same or different treatment sites over time, etc. Moreover, the method 600 can optionally include securing the tissue scaffold to the treatment site before removing the positioner, e.g., using adhesives, fasteners, bands, mechanical coupling, etc.

### II. Overview of Additive Manufacturing Technology

The systems, methods, and devices described herein may be fabricated via a wide variety of additive manufacturing techniques. Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,624 and U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Pat. No. 10,162,264 and U.S. Patent Publication No. 2014/0265034, the disclosures of which are incorporated herein by reference in their entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

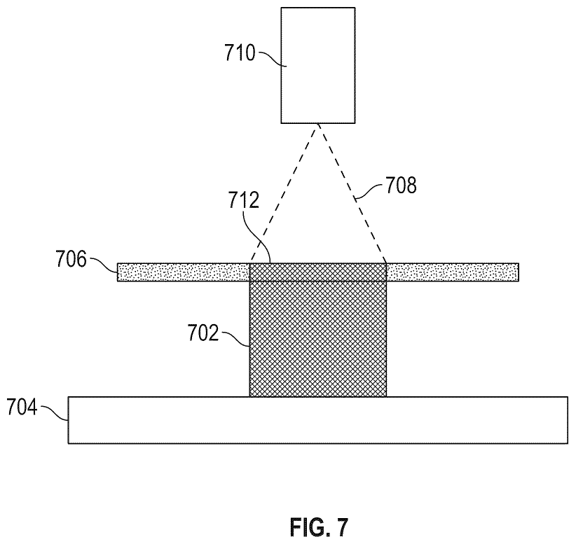

FIG. 7 is a partially schematic diagram providing a general overview of an additive manufacturing process, in accordance with embodiments of the present technology. Additive manufacturing (also referred to herein as “3D printing”) includes a variety of technologies which fabricate 3D objects directly from digital models through an additive process. In some embodiments, additive manufacturing includes depositing a precursor material (e.g., a polymeric resin) onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

For example, in the embodiment of FIG. 7, an object 702 is fabricated on a build platform 704 from a series of cured material layers, with each layer having a geometry corresponding to a respective cross-section of the object 702. To fabricate an individual object layer, a layer of curable material 706 (e.g., polymerizable resin) is brought into contact with the build platform 704 (when fabricating the first layer of the object 702) or with the previously formed portion of the object 702 on the build platform 704 (when fabricating subsequent layers of the object 702). In some embodiments, the curable material 706 is formed on and supported by a substrate (not shown), such as a film. Energy 708 (e.g., light) from an energy source 710 (e.g., a laser, projector, or light engine) is then applied to the curable material 706 to form a cured material layer 712 on the build platform 704 or on the object 702. The remaining curable material 706 can then be moved away from the build platform 704 (e.g., by lowering the build platform 704, by moving the build platform 704 laterally, by raising the curable material 706, and/or by moving the curable material 706 laterally), thus leaving the cured material layer 712 in place on the build platform 704 and/or object 702. The fabrication process can then be repeated with a fresh layer of curable material 706 to build up the next layer of the object 702.

The illustrated embodiment shows a “top down” configuration in which the energy source 710 is positioned above and directs the energy 708 down toward the build platform 704, such that the object 702 is formed on the upper surface of the build platform 704. Accordingly, the build platform 704 can be incrementally lowered relative to the energy source 710 as successive layers of the object 702 are formed. In other embodiments, however, the additive manufacturing process of FIG. 7 can be performed using a “bottom up” configuration in which the energy source 710 is positioned below and directs the energy 708 up toward the build platform 704, such that the object 702 is formed on the lower surface of the build platform 704. Accordingly, the build platform 704 can be incrementally raised relative to the energy source 710 as successive layers of the object 702 are formed.

Although FIG. 7 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

### EXAMPLES

The following examples are included to further describe some aspects of the present technology, and should not be used to limit the scope of the technology.
Example 1. A device for treating an intraoral cavity of a patient, the device comprising:
a tissue scaffold configured to promote growth of oral tissue at a treatment site in the intraoral cavity of the patient; and
a positioner comprising:
   one or more cavities configured to receive one or more teeth of the patient, and
   an alignment element configured to temporarily couple to the tissue scaffold such that when the positioner is placed on the patient's teeth, the alignment element locates the tissue scaffold at the treatment site.
Example 2. The device of Example 1, wherein the tissue scaffold comprises one or more polymers.
Example 3. The device of Example 2, wherein the one or more polymers comprise one or more of the following: an aliphatic polyester, a polyanhydride, a polyphosphazene, or a poly(ethylene glycol).
Example 4. The device of any one of Examples 1 to 3, wherein the tissue scaffold comprises one or more bioactive agents.
Example 5. The device of Example 4, wherein the one or more bioactive agents comprise one or more of the following: a growth factor, an inorganic mineral, a small molecule drug, or a cell.
Example 6. The device of any one of Examples 1 to 5, wherein the tissue scaffold is biodegradable.
Example 7. The device of any one of Examples 1 to 5, wherein the tissue scaffold is non-biodegradable.
Example 8. The device of any one of Examples 1 to 7, wherein the tissue scaffold comprises a plurality of different materials.
Example 9. The device of Example 8, wherein at least some of the different materials have different moduli.
Example 10. The device of Example 9, wherein the different moduli correspond to different types of oral tissues to be regenerated.
Example 11. The device of any one of Examples 8 to 10, wherein the tissue scaffold comprises:
a first portion composed of a first material, and
a second portion composed of a second material.
Example 12. The device of Example 11, wherein the first material is configured to promote growth of soft tissue in the first portion of the tissue scaffold, and wherein the second material is configured to promote growth of bone tissue in the second portion of the tissue scaffold.
Example 13. The device of any one of Examples 1 to 12, wherein the tissue scaffold comprises surface features that are configured to pierce into tissue at the treatment site.
Example 14. The device of any one of Examples 1 to 13, wherein the tissue scaffold comprises a plurality of additively manufactured polymer layers.
Example 15. The device of any one of Examples 1 to 14, wherein the positioner comprises a polymeric shell with the one or more cavities.
Example 16. The device of any one of Examples 1 to 14, wherein the positioner comprises one or more registration elements with the one or more cavities.
Example 17. The device of any one of Examples 1 to 16, wherein the alignment element comprises an opening configured to receive at least a portion of the tissue scaffold.
Example 18. The device of any one of Examples 1 to 16, wherein the alignment element comprises one or more releasable connections to the tissue scaffold.
Example 19. The device of Example 18, wherein the one or more releasable connections are configured to fracture to release the tissue scaffold from the alignment element.
Example 20. The device of any one of Examples 1 to 19, wherein the positioner is configured to be removed from the tissue scaffold while the tissue scaffold remains in place at the treatment site.
Example 21. The device of any one of Examples 1 to 20, wherein the positioner comprises a plurality of additively manufactured polymer layers.
Example 22. The device of any one of Examples 1 to 21, wherein the tissue scaffold and the positioner are integrally formed with each other.
Example 23. The device of any one of Examples 1 to 21, wherein the tissue scaffold and the positioner are discrete components.
Example 24. The device of any one of Examples 1 to 23, wherein the tissue scaffold and the positioner are fabricated from the same material.
Example 25. The device of any one of Examples 1 to 23, wherein the tissue scaffold is fabricated from a first material, and the positioner is fabricated from a second, different material.
Example 26. The device of any one of Examples 1 to 25, wherein the oral tissue comprises one or more of gingiva, ligaments, cementum, or bone.
Example 27. The device of any one of Examples 1 to 26, wherein the treatment site comprises a gum recession site, a periodontitis site, or a bone loss site.
Example 28. A method comprising:
placing a positioner onto one or more teeth in an intraoral cavity of a patient;
using the positioner to locate a tissue scaffold at a treatment site in the intraoral cavity, wherein the tissue scaffold is configured to promote growth of oral tissue at the treatment site; and
removing the positioner from the one or more teeth while the tissue scaffold remains in place at the treatment site.
Example 29. The method of Example 28, further comprising securing the tissue scaffold to the treatment site via an adhesive.
Example 30. The method of Example 29, further comprising applying the adhesive to the tissue scaffold before the tissue scaffold is located at the treatment site.
Example 31. The method of any one of Examples 28 to 30, further comprising applying the adhesive to the treatment site before the tissue scaffold is located at the treatment site.
Example 32. The method of any one of Examples 28 to 31, wherein the tissue scaffold comprises one or more polymers.
Example 33. The method of Example 32, wherein the one or more polymers comprise one or more of the following: an aliphatic polyester, a polyanhydride, a polyphosphazene, or a poly(ethylene glycol).
Example 34. The method of any one of Examples 28 to 33, wherein the tissue scaffold comprises one or more bioactive agents.
Example 35. The method of Example 34, wherein the one or more bioactive agents comprise one or more of the following: a growth factor, an inorganic mineral, a small molecule drug, or a cell.
Example 36. The method of any one of Examples 28 to 35, wherein the tissue scaffold is biodegradable.
Example 37. The method of any one of Examples 28 to 35, wherein the tissue scaffold is non-biodegradable.
Example 38. The method of any one of Examples 28 to 37, wherein the tissue scaffold comprises a plurality of different materials.
Example 39. The method of Example 38, wherein at least some of the different materials have different moduli.
Example 40. The method of Example 39, wherein the different moduli correspond to different types of oral tissues to be regenerated.
Example 41. The method of any one of Examples 38 to 40, wherein the tissue scaffold comprises:
a first portion composed of a first material, and
a second portion composed of a second material.
Example 42. The method of Example 41, wherein the first material is configured to promote growth of soft tissue in the first portion of the tissue scaffold, and wherein the second material is configured to promote growth of bone tissue in the second portion of the tissue scaffold.
Example 43. The method of any one of Examples 28 to 42, further comprising piercing tissue at the treatment site before or concurrently with the locating of the tissue scaffold.
Example 44. The method of any one of Examples 28 to 43, wherein the tissue scaffold comprises a plurality of additively manufactured polymer layers.
Example 45. The method of any one of Examples 28 to 44, wherein the positioner comprises a polymeric shell having one or more cavities configured to receive the one or more teeth.
Example 46. The method of any one of Examples 28 to 44, wherein the positioner comprises one or more registration elements having one or more cavities configured to receive the one or more teeth.
Example 47. The method of any one of Examples 28 to 46, wherein the tissue scaffold is located at the treatment site by placing at least a portion of the tissue scaffold into an opening in the positioner.
Example 48. The method of any one of Examples 28 to 46, wherein the tissue scaffold is located at the treatment site using one or more releasable connection that couple the tissue scaffold to the positioner.
Example 49. The method of Example 48, further comprising fracturing the one or more releasable connections to release the tissue scaffold from the positioner.
Example 50. The method of any one of Examples 28 to 49, wherein the positioner comprises a plurality of additively manufactured polymer layers.
Example 51. The method of any one of Examples 28 to 50, wherein the tissue scaffold and the positioner are integrally formed with each other.
Example 52. The method of any one of Examples 28 to 50, wherein the tissue scaffold and the positioner are discrete components.
Example 53. The method of any one of Examples 28 to 52, wherein the tissue scaffold and the positioner are fabricated from the same material.
Example 54. The method of any one of Examples 28 to 52, wherein the tissue scaffold is fabricated from a first material, and the positioner is fabricated from a second, different material.
Example 55. The method of any one of Examples 28 to 54, wherein the oral tissue comprises one or more of gingiva, ligaments, cementum, or bone.
Example 56. The method of any one of Examples 28 to 55, wherein the treatment site comprises a gum recession site, a periodontitis site, or a bone loss site.
Example 57. A method comprising:
receiving a digital representation of an intraoral cavity of a patient, the digital representation depicting one or more teeth and a treatment site in the intraoral cavity;
generating a digital representation of a tissue scaffold for placement at the treatment site, wherein the tissue scaffold is configured to promote growth of oral tissue at the treatment site;
generating a digital representation of a positioner configured to receive the one or more teeth and to temporarily couple to the tissue scaffold to locate the tissue scaffold at the treatment site; and
generating instructions for fabricating one or more of the tissue scaffold or the positioner, based on one or more of the digital representation of the tissue scaffold or the digital representation of the positioner.
Example 58. The method of Example 57, wherein the digital representation of the intraoral cavity comprises or is based on scan data of the intraoral cavity.
Example 59. The method of Example 57 or 58, wherein the digital representation of the intraoral cavity comprises or is based on radiographic data of the intraoral cavity.
Example 60. The method of any one of Examples 57 to 59, wherein generating the digital representation of the tissue scaffold comprises:
identifying a geometry of the treatment site, based on the digital representation of the intraoral cavity, and
determining a geometry for the tissue scaffold to fit the treatment site.
Example 61. The method of any one of Examples 57 to 60, wherein generating the digital representation of the tissue scaffold comprises:
identifying a tissue type at the treatment site, based on the digital representation of the intraoral cavity, and
selecting one or more of a material or a structure for the tissue scaffold, based on the tissue type.
Example 62. The method of any one of Examples 57 to 61, wherein the tissue scaffold comprises one or more polymers.
Example 63. The method of any one of Examples 57 to 62, wherein the tissue scaffold comprises one or more bioactive agents.
Example 64. The method of any one of Examples 57 to 63, wherein the tissue scaffold comprises a plurality of different materials.
Example 65. The method of Example 64, wherein at least some of the different materials have different moduli.
Example 66. The method of Example 65, wherein the different moduli correspond to different types of oral tissues to be regenerated.
Example 67. The method of any one of Examples 57 to 66, wherein the tissue scaffold comprises:
a first portion composed of a first material, and
a second portion composed of a second material.
Example 68. The method of Example 67, wherein the first material is configured to promote growth of soft tissue in the first portion of the tissue scaffold, and wherein the second material is configured to promote growth of bone tissue in the second portion of the tissue scaffold.
Example 69. The method of any one of Examples 57 to 68, wherein generating the digital representation of the positioner comprises:
identifying a location of the treatment site, based on the digital representation of the intraoral cavity, and
determining a geometry for an alignment element of the positioner such that coupling of the tissue scaffold to the alignment element locates the tissue scaffold at the location of the treatment site.
Example 70. The method of Example 69, wherein the alignment element comprises an opening configured to receive at least a portion of the tissue scaffold.
Example 71. The method of Example 69, wherein the alignment element comprises one or more releasable connections to the tissue scaffold.
Example 72. The method of Example 71, wherein the one or more releasable connections are configured to fracture to release the tissue scaffold from the alignment element.
Example 73. The method of any one of Examples 57 to 72, wherein generating the digital representation of the positioner comprises determining a geometry for one or more cavities of the positioner configured to receive the one or more teeth, based on the digital representation of the intraoral cavity.
Example 74. The method of Example 73, wherein the positioner comprises a polymeric shell having the one or more cavities configured to receive the one or more teeth.
Example 75. The method of Example 73, wherein the positioner comprises one or more registration elements having the one or more cavities configured to receive the one or more teeth.
Example 76. The method of any one of Examples 57 to 75, wherein the instructions are configured to cause fabrication of the tissue scaffold via an additive manufacturing process.
Example 77. The method of any one of Examples 57 to 76, wherein the instructions are configured to cause fabrication of the positioner via an additive manufacturing process.
Example 78. The method of any one of Examples 57 to 77, wherein the instructions are configured to cause the tissue scaffold and the positioner to be fabricated integrally with each other.
Example 79. The method of any one of Examples 57 to 78, wherein the instructions are configured to cause the tissue scaffold and the positioner to be fabricated as two discrete components.
Example 80. The method of any one of Examples 57 to 79, wherein the instructions are configured to cause the tissue scaffold and the positioner to be fabricated from the same material.
Example 81. The method of any one of Examples 57 to 79, wherein the instructions are configured to cause the tissue scaffold to be fabricated from a first material, and to cause the positioner to be fabricated from a second, different material.
Example 82. The method of any one of Examples 57 to 81, further comprising fabricating the one or more of the tissue scaffold or the positioner, based on the instructions.
Example 83. The method of any one of Examples 57 to 82, wherein the oral tissue comprises one or more of gingiva, ligaments, cementum, or bone.
Example 84. The method of any one of Examples 57 to 83, wherein the treatment site comprises a gum recession site, a periodontitis site, or a bone loss site.
Example 85. A system comprising:
one or more processors; and
a memory operably coupled to the one or more processors and storing instructions that, when executed by the one or more processors, cause the system to perform operations comprising:
   receiving a digital representation of an intraoral cavity of a patient, the digital representation depicting one or more teeth and a treatment site in the intraoral cavity,
   generating a digital representation of a tissue scaffold for placement at the treatment site, wherein the tissue scaffold is configured to promote growth of oral tissue at the treatment site,
   generating a digital representation of a positioner configured to receive the one or more teeth and to temporarily couple to the tissue scaffold to locate the tissue scaffold at the treatment site, and
   generating fabrication instructions for fabricating one or more of the tissue scaffold or the positioner, based on one or more of the digital representation of the tissue scaffold or the digital representation of the positioner.
Example 86. The system of Example 85, wherein the digital representation of the intraoral cavity comprises or is based on scan data of the intraoral cavity.
Example 87. The system of Example 85 or 86, wherein the digital representation of the intraoral cavity comprises or is based on radiographic data of the intraoral cavity.
Example 88. The system of any one of Examples 85 to 87, wherein generating the digital representation of the tissue scaffold comprises:
identifying a geometry of the treatment site, based on the digital representation of the intraoral cavity, and
determining a geometry for the tissue scaffold to fit the treatment site.
Example 89. The system of any one of Examples 85 to 88, wherein generating the digital representation of the tissue scaffold comprises:
identifying a tissue type at the treatment site, based on the digital representation of the intraoral cavity, and
selecting one or more of a material or a structure for the tissue scaffold, based on the tissue type.
Example 90. The system of any one of Examples 85 to 89, wherein the tissue scaffold comprises one or more polymers.
Example 91. The system of any one of Examples 85 to 90, wherein the tissue scaffold comprises one or more bioactive agents.
Example 92. The system of any one of Examples 85 to 91, wherein the tissue scaffold comprises a plurality of different materials.
Example 93. The system of Example 92, wherein at least some of the different materials have different moduli.
Example 94. The system of Example 93, wherein the different moduli correspond to different types of oral tissues to be regenerated.
Example 95. The system of any one of Examples 85 to 94, wherein the tissue scaffold comprises:
a first portion composed of a first material, and
a second portion composed of a second material.
Example 96. The system of Example 95, wherein the first material is configured to promote growth of soft tissue in the first portion of the tissue scaffold, and wherein the second material is configured to promote growth of bone tissue in the second portion of the tissue scaffold.
Example 97. The system of any one of Examples 85 to 96, wherein generating the digital representation of the positioner comprises:
identifying a location of the treatment site, based on the digital representation of the intraoral cavity, and
determining a geometry for an alignment element of the positioner such that coupling of the tissue scaffold to the alignment element locates the tissue scaffold at the location of the treatment site.
Example 98. The system of Example 97, wherein the alignment element comprises an opening configured to receive at least a portion of the tissue scaffold.
Example 99. The system of Example 97, wherein the alignment element comprises one or more releasable connections to the tissue scaffold.
Example 100. The system of Example 99, wherein the one or more releasable connections are configured to fracture to release the tissue scaffold from the alignment element.
Example 101. The system of any one of Examples 85 to 100, wherein generating the digital representation of the positioner comprises determining a geometry for one or more cavities of the positioner configured to receive the one or more teeth, based on the digital representation of the intraoral cavity.
Example 102. The system of Example 101, wherein the positioner comprises a polymeric shell having the one or more cavities configured to receive the one or more teeth.
Example 103. The system of Example 101, wherein the positioner comprises one or more registration elements having the one or more cavities configured to receive the one or more teeth.
Example 104. The system of any one of Examples 85 to 103, wherein the fabrication instructions are configured to cause fabrication of the tissue scaffold via an additive manufacturing process.
Example 105. The system of any one of Examples 85 to 104, wherein the fabrication instructions are configured to cause fabrication of the positioner via an additive manufacturing process.
Example 106. The system of any one of Examples 85 to 105, wherein the fabrication instructions are configured to cause the tissue scaffold and the positioner to be fabricated integrally with each other.
Example 107. The system of any one of Examples 85 to 106, wherein the fabrication instructions are configured to cause the tissue scaffold and the positioner to be fabricated as two discrete components.
Example 108. The system of any one of Examples 85 to 107, wherein the fabrication instructions are configured to cause the tissue scaffold and the positioner to be fabricated from the same material.
Example 109. The system of any one of Examples 85 to 107, wherein the fabrication instructions are configured to cause the tissue scaffold to be fabricated from a first material, and to cause the positioner to be fabricated from a second, different material.
Example 110. The system of any one of Examples 85 to 109, wherein the operations further comprise fabricating the one or more of the tissue scaffold or the positioner, based on the fabrication instructions.
Example 111. The system of any one of Examples 85 to 110, wherein the oral tissue comprises one or more of gingiva, ligaments, cementum, or bone.
Example 112. The system of any one of Examples 85 to 111, wherein the treatment site comprises a gum recession site, a periodontitis site, or a bone loss site.

### Conclusion

Although many of the embodiments are described above with respect to systems, devices, and methods for regeneration of oral tissues, the technology is applicable to other applications and/or other approaches, such as regeneration of tissues at other anatomical locations. For example, the tissue scaffolds described herein may be used to regrow ligaments by adhering the tissue scaffold to bone treatment site(s). Additionally, although certain embodiments are focused on treatment of humans, the embodiments herein are also applicable to treatment of animals. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-7.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A device for treating an intraoral cavity of a patient, the device comprising:
a tissue scaffold configured to promote growth of oral tissue at a treatment site in the intraoral cavity of the patient; and
a positioner comprising:
one or more cavities configured to receive one or more teeth of the patient, and
an alignment element configured to temporarily couple to the tissue scaffold such that when the positioner is placed on the patient's teeth, the alignment element locates the tissue scaffold at the treatment site.

2. The device of claim 1, wherein the tissue scaffold comprises one or more polymers.

3. The device of claim 2, wherein the one or more polymers comprise one or more of the following: an aliphatic polyester, a polyanhydride, a polyphosphazene, or a poly(ethylene glycol).

4. The device of claim 1, wherein the tissue scaffold comprises one or more bioactive agents.

5. The device of claim 4, wherein the one or more bioactive agents comprise one or more of the following: a growth factor, an inorganic mineral, a small molecule drug, or a cell.

6. The device of claim 1, wherein the tissue scaffold comprises a plurality of different materials, and wherein at least some of the different materials have different moduli corresponding to different types of oral tissues to be regenerated.

7. The device of claim 6, wherein the tissue scaffold comprises:
a first portion composed of a first material, wherein the first material is configured to promote growth of soft tissue in the first portion of the tissue scaffold, and
a second portion composed of a second material, wherein the second material is configured to promote growth of bone tissue in the second portion of the tissue scaffold.

8. The device of claim 1, wherein the tissue scaffold comprises surface features that are configured to pierce into tissue at the treatment site.

9. The device of claim 1, wherein the tissue scaffold comprises a plurality of additively manufactured polymer layers.

10. The device of claim 1, wherein the positioner comprises a polymeric shell with the one or more cavities.

11. The device of claim 1, wherein the positioner comprises one or more registration elements with the one or more cavities.

12. The device of claim 1, wherein the alignment element comprises an opening configured to receive at least a portion of the tissue scaffold.

13. The device of claim 1, wherein the alignment element comprises one or more releasable connections to the tissue scaffold.

14. The device of claim 13, wherein the one or more releasable connections are configured to fracture to release the tissue scaffold from the alignment element.

15. The device of claim 1, wherein the positioner is configured to be removed from the tissue scaffold while the tissue scaffold remains in place at the treatment site.

16. The device of claim 1, wherein the positioner comprises a plurality of additively manufactured polymer layers.

17. The device of claim 1, wherein the tissue scaffold and the positioner are integrally formed with each other.

18. The device of claim 1, wherein the tissue scaffold and the positioner are discrete components.

19. The device of claim 1, wherein the oral tissue comprises one or more of gingiva, ligaments, cementum, or bone.

20. The device of claim 1, wherein the treatment site comprises a gum recession site, a periodontitis site, or a bone loss site.
